(19) United States
(12) Patent Application Publication
(10) Pub. No.: US 2015/0090396 A1
(43) Pub. Date: Apr. 2, 2015

(54) SET OF TOOLS FOR PRODUCING A COMPOSITE PART

(71) Applicant: AIRCELLE, GONFREVILLE L'ORCHER (FR)

(72) Inventors: Guy Bernard VAUCHEL, Harfleur (FR); Eric PILLON, Benarville (FR); Denis GRENET, (US); Maxime COIN, Boulleville (FR)

(21) Appl. No.: 14/567,006

(22) Filed: Dec. 11, 2014

Related U.S. Application Data
(63) Continuation of application No. PCT/FR2013/051347, filed on Jun. 11, 2013.

(30) Foreign Application Priority Data
Jun. 12, 2012 (FR) 12/55463

(51) Int. Cl. B32B 37/10; B32B 38/00; B32B 37/24

(52) U.S. Cl. CPC B32B 37/10; B32B 37/24; B32B 38/00; B32B 2038/0076; B32B 2305/024
USPC 156/242; 156/580

(57) ABSTRACT

The present disclosure relates to a set of tools for producing a composite part with a circumference higher than 180° having at least one convex surface which cannot be stripped. The set of tools includes at least one core and a plurality of keys. One of the keys includes supporting and holding walls, and a lateral wall. The supporting wall has a shape substantially similar to the shape of a working wall of the core, and the holding wall supports at least in part a first skin of the composite part to be produced. Furthermore, the lateral wall includes a holder to maintain together at least two adjacent keys, and the holder allows a circumferential clearance between adjacent lateral walls of the two adjacent keys.

### CROSS-REFERENCE TO RELATED APPLICATIONS

This application is a continuation of International Application No. PCT/FR2013/051347, filed on Jun. 11, 2013, which claims the benefit of FR 12/55463, filed on Jun. 12, 2012. The disclosures of the above applications are incorporated herein by reference.

### FIELD

The present disclosure relates to a set of tools for producing a composite part and a method for producing a composite part.

### BACKGROUND

The statements in this section merely provide background information related to the present disclosure and may not constitute prior art.

Producing a part in composite material may be achieved by a step of drape molding of plies against a male shape, that is to say, by pressing against a male shape several carbon plies, pre-impregnated or not with a resin, then by a polymerization step, that is to say, by heating the set in a furnace in order to give the plies the required stiffness.

The part thus constituted is hence able to be stripped by mold removal.

Producing parts with a circumference lower than 180° is relatively easy to produce. However, the same cannot be said for parts having geometries which extend over an important angular area, in particular higher than 180°, and having lines that cannot be extracted from the mold after making the part.

An example of part which is particularly difficult to make in composite material by this type of method is an outer structure of a turbojet engine nacelle such as a mobile cowl of thrust reverser, for a nacelle structure of “O-Duct” type.

An aircraft is moved by several turbojet engines each housed in a nacelle serving to channel the air flows generated by the turbojet engine, and which may also accommodate a set of devices providing diverse functions such as a thrust reversal device of which the role is to improve the braking capacity of the airplane by redirecting towards the front at least part of the air of the secondary flow.

A nacelle generally exhibits a tubular structure comprising an air inlet upstream of the turbojet engine, a median section intended to surround a turbojet engine fan, a downstream section accommodating the thrust reversal means and intended to surround the combustion chamber of the turbojet engine, and is generally ended by an ejection nozzle of which the outlet is located downstream of the turbojet engine.

It is known a nacelle intended to be supported by a pylon of the turbojet engine comprising a thrust reversal device having a unique single piece mobile cowl substantially peripheral and quasi annular, slidably mounted on rails disposed on either side of said pylon.

Such a cowl is often designated by “O-duct”, referring to the shape of the shell of such a cowl, by opposition to “D-duct”, which in fact comprises two half-cowls each extending over a half-circumference of the nacelle.

The producing of such a single piece cowl, having at least a convex shape, is in a known manner made thanks to a “key” tool.

Such a tool generally exhibits three, four or five parts called “keys” of which the fixing together is done inside the structure, either mechanically by bolting, or by an automatic connection and key handling system, everything being enveloped by a plastic bladder.

The permeability of the tool is according to the prior art added on the bladder by enveloping the tool on the outside and on the inside. A major drawback of this type of solution is linked to the size of the bladder and its manipulation. The adjustment of the bladder in the inner part of the mold is relatively complicated, the size of the bladder is important and its manipulation complex, thus leading to an important risk of loss of vacuum during polymerization.

Furthermore, the keys provide the structural resistance of the tool. As a result they are generally metallic, thus considerably increasing the mass of the set of tools, and the production cost of such keys.

It is also known a tool for which the keys themselves are made permeable. Nevertheless, the sealing system of the keys is not reliable, thus making unpredictable the compacting quality of the structure during the vacuum polymerization and pressurization of the autoclave.

It is also known from the prior art the patent application published under number GB 2 460 741, and with the purpose more particularly to remedy to the drawbacks resulting from the large size of the bladder. In this document of the prior art, the tool comprises a central inner core on which is positioned a plurality of non-permeable keys. The permeability is directly achieved on the inner core, thus allowing to be free of the issues pertaining to the encumbrance of the bladder as it no longer necessary to envelop the inner part of the mold.

On the other hand, the inner wall of the keys substantially adopts the same shape as the outer wall of the core, and the keys are bolted together at their lateral walls.

The stiff bolting of keys together allows optimal clamping between the lateral walls of the keys. However, when the keys are positioned on the core, such a contact between the keys leads to an unpredictable contact between the inner walls of the keys and the outer wall of the core, due to the mechanical tolerances of each of the produced parts. This leads to a bad centering of the keys on the core, and as a result an imperfection of the composite part produced.

Furthermore, the inner parts of the keys might also be clamped on the outer wall of the inner core, thus leading to a bad clamping of the keys together, thus creating micro-slits between the keys. Such micro-slits cause, during curing, for example skins pre-impregnated with resin, a stream of the resin between the micro-slits, able to create aerodynamic accidents of the produced composite structure.

### SUMMARY

The present disclosure provides a tool for the production of a part in composite material which cannot be stripped, of which the bladder is of reduced size and the placing thereof is made easy, and of which said tool allows respecting in a highly precise manner the dimensions of the composite parts to be produced.

To this end, the present disclosure provides a set of tools for producing a composite part with a circumference higher than 180° having at least one convex surface which cannot be stripped, said set comprising at least a core and a plurality of keys, at least one of said keys comprising at least a supporting wall, the shape of said supporting wall being substantially similar to that of a working wall of said core, at least one holding wall intended to support at least in part a first skin of said composite part to be produced, and at least one lateral wall comprising maintaining means shaped for maintaining together at least two adjacent keys, said set of tools being characterized in that the means for maintaining the keys allow a clearance, which is at least circumferential, between at least two adjacent lateral walls of the keys.

Thus, by providing maintaining means allowing a clearance between the lateral walls of the keys, a minimum displacement of the keys along the working wall of the inner core is allowed. Such a displacement allows a proper centering of said keys around the core, thus providing in a precise manner the required inner dimensioning of the composite part to be produced.

According to a first form of the maintaining means, said maintaining means comprise elastic means.

According to a second form, the maintaining means comprise at least a sliding bolt moveable between a prominent position and a retracted position.

Advantageously, at least one lateral wall of at least one key comprises at least one ramp for locking the maintaining means.

According to a feature of the set of tools according to the present disclosure, the working wall of the core is of substantially cylindrical shape and said core comprises at least a handling wall of a diameter substantially higher than the diameter of the working wall.

Furthermore, the core comprises a stop for positioning the set of keys.

The set of tools comprises at least two distinct contact areas between the set of keys and the core.

Advantageously, the core comprises on its inside a handling base intended to be manipulated by an outer handling device.

Thus, by positioning a manipulation base inside the core, it prevents having a sub plate which goes over the mold, thus allowing to reduce the surface on the ground required for placing the set of tools and have a better access for the operator during the drape molding phase. Moreover, thanks to this configuration of the handling base, it is relatively easy to provide a centre finder at the upper and lower parts of the core, advantageously allowing a positioning of the set in vertical position or in horizontal position.

In another form, at least one of the keys comprises at least one lifting ring intended to cooperate with at least one lifting sling.

The present disclosure also relates to a method for producing a composite part, characterized in that it comprises the following steps:

draping and polymerizing a first open skin with a circumference higher than 180° by means of a mold comprising at least a continuous drape molding surface;

positioning said first skin on the holding walls of the set of keys of the set of tools defined according to the present disclosure;

fixing at least one honeycomb core structure on said first skin;

fixing a plurality of composite plies on said honeycomb core structure in such a manner as to constitute a second skin and form a pre-cured composite part;

positioning a bladder at the extreme parts of the core in such a manner as to envelop the first skin, the honeycomb core structure and the second skin;

polymerizing the set of tools comprising the pre-cured composite part and the bladder;

removing the bladder;

extracting the set comprising the set of keys and the produced composite part;

disassembling the set of keys.

Thus, by incorporating the producing method of a first skin achieved by means of a continuous surface mold, the resin is prevented from penetrating into the spaces defined by the clearances between the keys during the polymerization. The permeability is provided by the first skin.

Moreover, such a first skin does not allow for draping over the mold of the composite plies on the discontinued keys, and it advantageously prevents aerodynamic accidents which may occur during the polymerization of the set.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents the set of tools according to the present disclosure;

FIG. 2 illustrates the core of the set of tools;

FIG. 3 is a detailed view centered on the stop for positioning the keys on the core;

FIG. 4 is a view of the set of keys;

FIG. 5 represents a key in isometric view;

FIG. 6 is a cross-sectional view of the keys, along line 6-6 of FIG. 4;

FIG. 7 is a detailed view illustrating the maintaining of the keys together according to a first form;

FIG. 8 illustrates the placing of the keys on the core when the maintaining of the keys together is achieved according to the first form;

FIG. 9 is a top view of the handling device;

FIG. 10 is a detailed view illustrating the maintaining of the keys together according to a first form;

FIG. 11 illustrates the placing of the keys on the core when maintaining the keys together is achieved according to the second form;

FIGS. 12 to 17 illustrate the steps of the method for producing a composite part:

FIG. 18 details the method for disassembling the keys when maintaining them together is achieved by the first form;

FIG. 19 represents the method for disassembling the keys when maintaining them together is achieved by the second form;

FIG. 20 illustrates the device for removing the keys; and

FIG. 21 represents the composite part resulting from the producing method according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

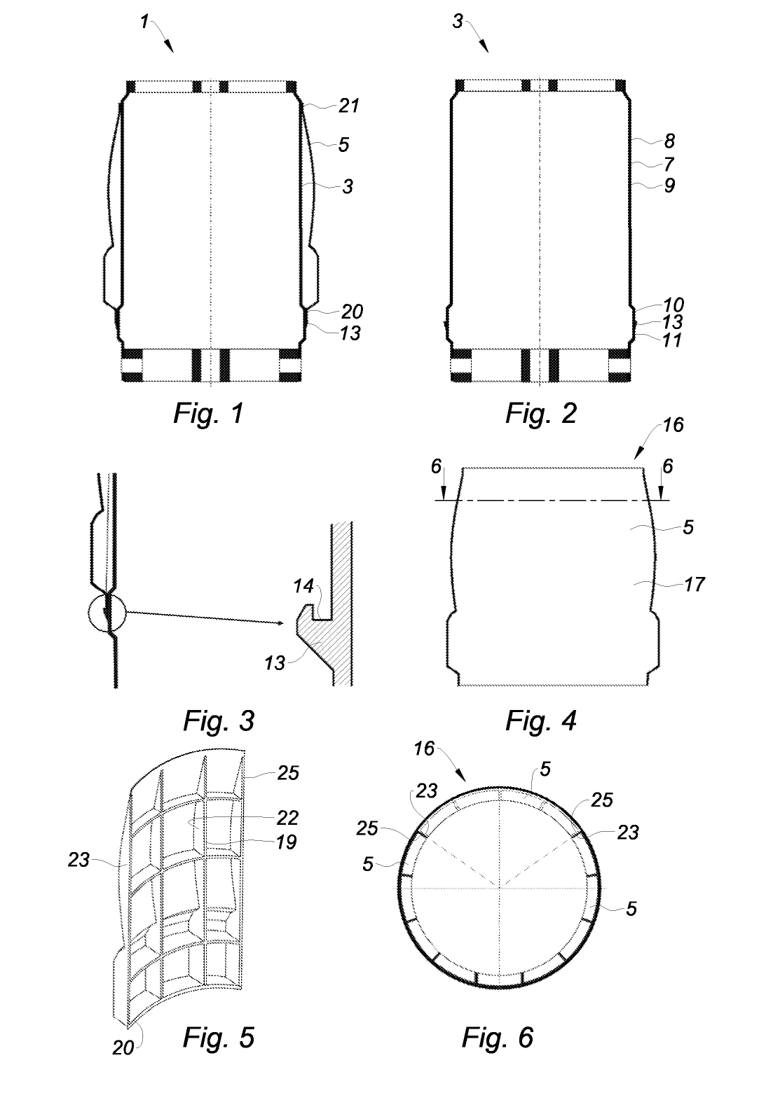

Furthermore, in the present description, words such as “upper” and “lower” are used, with reference to the position of the set of tools when the latter is in vertical position, a position according to which the core rests on the ground, as illustrated on FIG. 1.

It is referred to FIG. 1, illustrating the set of tools according to the present disclosure.

The set of tools 1 comprises a core 3 of substantially cylindrical shape, on which is positioned a plurality of keys 5.

By referring to FIG. 2, the core 3 comprises an outer wall 7, of which its upper part 8 forms a wall called working wall 9.

The core also comprises a handling wall 10 in lower part 11 of the outer wall 7.

The working wall 9, preferably plane, adopts a substantially cylindrical shape of constant diameter.

The handling wall 10 is substantially cylindrical, with a diameter substantially larger than that of the working wall 9. The handling wall allows the manipulation of the core thanks to an outer handling device (not represented on this figure).

The handling wall exhibits a positioning stop 13 allowing maintaining the keys on the core 3. With reference to FIG. 3 illustrating an enlarged view of the positioning stop 13, said stop exhibits a groove 14 for receiving the lower part of the keys.

However, the positioning stop may, according to one form not represented on the figures, be directly achieved on the working wall.

According to this form, the working wall is flared in its lower part, such as to allow a contact between the keys and the core only at the end of the positioning of the keys on the core.

With reference again to FIG. 2, the lower part 11 of the core comprises inside it a handling base 15, cooperating with the handling device, as explained in further detail in the rest of the description.

According to one form not represented on the figures, the core is directly placed on the ground, the inner wall being no longer equipped with the handling base.

The core, for example metallic, is achieved from a material with a low dilation coefficient in order to limit the deformation thereof during the placing the set in the autoclave.

With reference to FIG. 4, a set 16 of keys is achieved by assembling several keys 5 together.

Obviously, the set of keys may comprise a different number of keys depending on the needs of the one skilled in the art.

The keys 5 each comprise a holding wall 17 together forming the surface of the part to produce when the keys are assembled together.

FIG. 5 illustrates a key in isometric view. The key 5 comprises a supporting wall 19 substantially similar to the profile of the working wall of the core.

In fact, a slight clearance may be provided between the working wall of the core and the supporting wall of the keys, in order to allow the removal of the core or keys when the polymerization phase is achieved, as described in further detail in the rest of the description.

The key 5 comprises a lower part 20 intended to be supported by the stop 13 for positioning the core, as represented on FIG. 1. The key 5 is also intended to come into contact with an upper part 21 of the working wall of the core, visible on FIG. 1.

Areas 13 and 21 of the core thus represent the two contact areas between the set of keys and the core.

However, additional contact areas between the keys and the core may be added inside the keys in order to prevent if necessary any deformation of the keys during the pressurization in the autoclave.

The key 5 may be hollow in such a manner as to reduce the mass of the set. The keys 5 are alternately achieved in composite materials also for the sake of limiting the mass of the set.

The key 5 further comprises structural reinforcements 22 providing the stiffness of the set of tools.

With reference to FIG. 6, each key 5 comprises two substantially plane lateral walls 23 and 25, each coming in contact with adjacent lateral walls in order to form the set 16 of keys.

The lateral walls 23 and 25 are represented in parallel, but may indifferently be slanted.

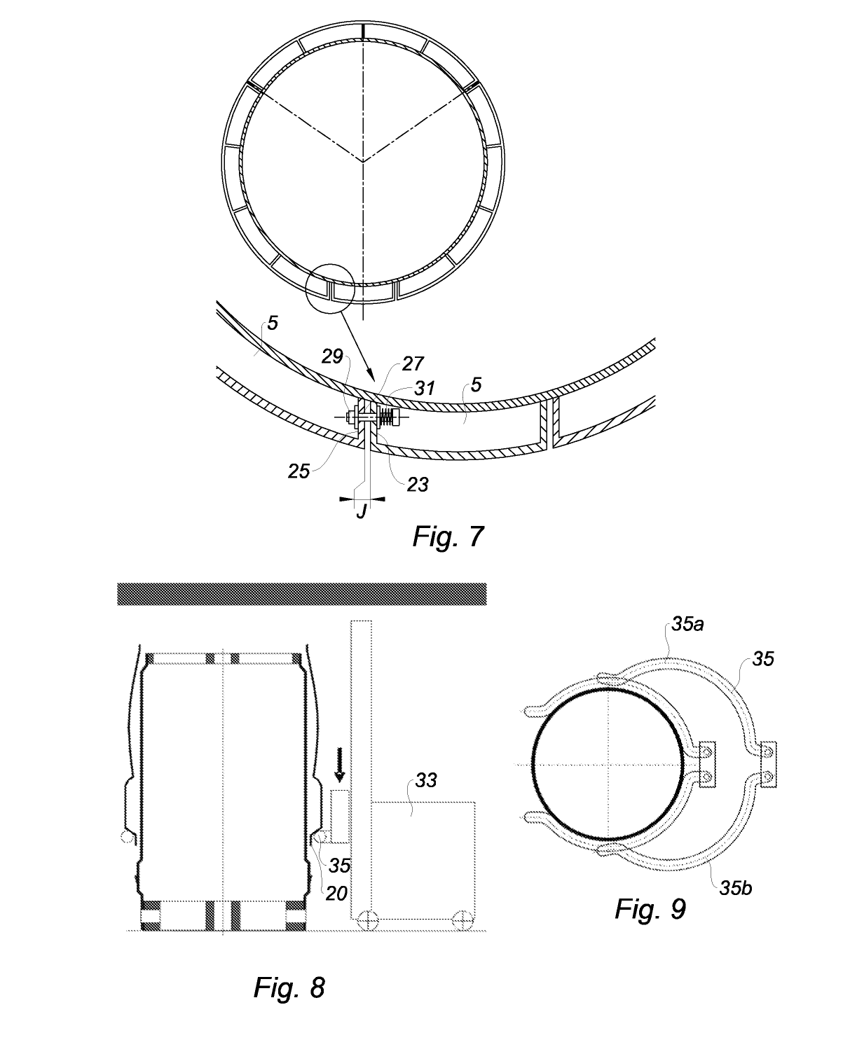

Reference is now made to FIG. 7, illustrating a first form of the maintaining of the keys.

The maintaining means between the keys 5 are positioned at the lateral wall 23 of the key 5.

According to a first form, the maintaining means comprise a screw 27 and a nut 29 cooperating with the screw and housed inside the adjacent key.

The screw 27 further comprises elastic means such as a spring 31, allowing a circumferential clearance J between the lateral walls 23 and 25 of the adjacent keys when the set of keys is constituted.

As described in further detail in the rest, the clearance J allows providing a proper centering of the keys on the core.

It is referred to FIGS. 8 and 9 illustrating the placing of the set of keys on the core.

The keys are assembled together before their positioning on the core. Thus, the set of keys is self-supported before its placing on the core, the lateral walls 23 being in contact with the lateral walls 25.

The positioning of the keys on the core is achieved thanks to a handling device such as a moveable power lift truck 33.

The power lift truck 33 comprises grasping brackets 35 allowing to grasp the set of keys at the lower part 20 of the keys 20.

The grasping brackets 35 are exhibited in the shape of two flexible pincers 35a and 35b mounted stationary on the power lift truck.

Alternatively, the pincers are stiff and each mounted pivotally around a longitudinal axis of the trolley.

According to a non-represented form, the handling device is stationary and integrated to the working station of an operator.

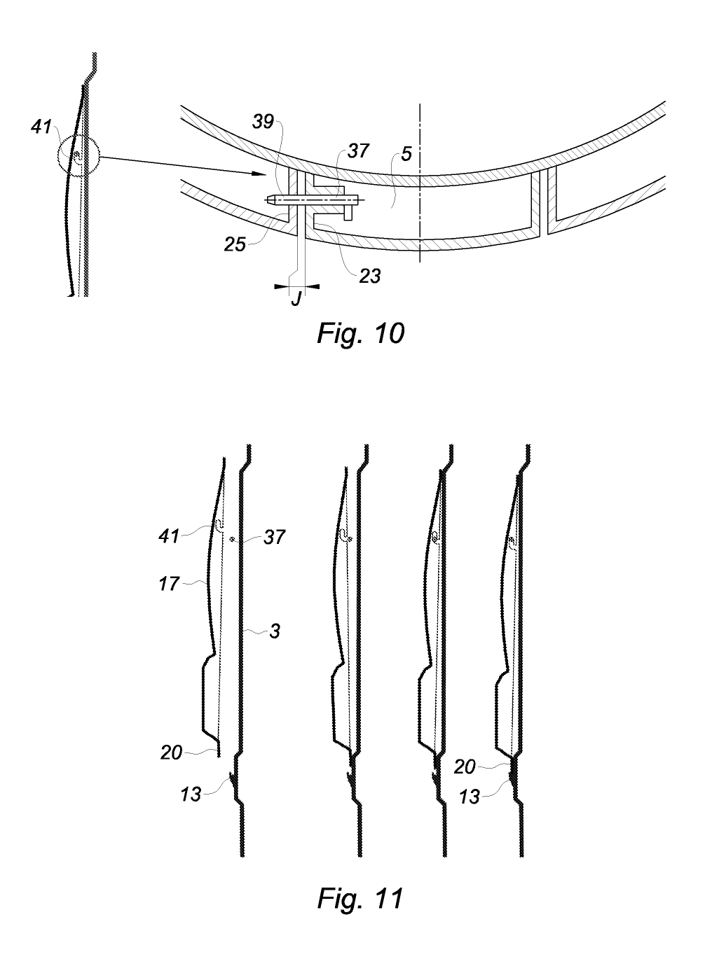

It is now referred to FIG. 10, illustrating a second form of the maintaining means between the keys.

According to this form, the maintaining means comprise a sliding bolt 37 supported by the lateral wall 23 of the key 5.

The sliding bolt 37 is represented in prominent position. In such a position, an extreme part 39 of the sliding bolt 37 cooperates with a locking ramp 41 secured to the adjacent key 5, providing the blocking in downward vertical translation of a key 5 with respect to the adjacent key.

The sliding bolt slides between a prominent position and a retracted position allowing the disassembling of the keys.

The sliding bolt 37 also allows a circumferential clearance J between the adjacent keys to provide a proper centering of the keys around the core.

According to this form, the assembling of the keys is carried out by positioning the keys one by one on the core, as represented on FIG. 11.

By referring to this figure, a first key is positioned on the core 3. The sliding bolt 37 is placed in prominent position.

The successive positioning of the keys is achieved by positioning the adjacent keys one by one. To this end, the locking ramp 41 of the second key is positioned facing the sliding bolt 37, then the extreme part of the sliding bolt is slid inside the locking ramp.

Simultaneously, the lower part 20 of the key is inserted in the stop 13 for positioning the core.

This method is iterated until the set of keys is positioned on the core and that the holding walls 17 form the surface of the part to be produced.

The part of the following description relates to a producing method according to the present disclosure.

The part that is sought to be produced is for example an acoustic panel intended to equip a turbojet engine nacelle in order to reduce the noise coming from certain portions of the set constituted by the nacelle and the turbojet engine.

Obviously, this example illustrates a particular form of the set of tools according to the present disclosure, and does not constitute any limitation to the producing of other composite parts of different nature and functionalities.

An acoustic panel, also called “sandwich panel” with reference to its structure, comprises a first skin, called “inner skin” on which is fixed a honeycomb core structure, intended to attenuate a noise, on which is fixed a second skin, called “outer skin”.

The outer skin designates the skin which is in contact with the secondary air flow circulation stream.

Typically, the outer skin is perforated in such a manner as to let the sound waves coming from the area to be acoustically attenuated pass, whereas the inner skin is full.

The producing method according to the present disclosure comprises a first step of drape molding and polymerization in an autoclave of a first skin.

It is assumed that the first skin of which reference is made in the aforementioned step of the producing method is an outer skin, that is to say, an acoustic skin.

However, it should be understood that said first skin may constitute either the inner skin of the acoustic panel, or the outer skin of said panel, according to the area of the nacelle which the acoustic panel is intended to equip.

According to one form example of the method according to the present disclosure, an acoustic panel is achieved for a single piece cowl of thrust reverser, for an “O-Duct” type nacelle structure.

The first step of the method for producing the acoustic panel is to produce a skin having a continuous surface allowing to provide, as explained in further detail in the rest of the description, a proper aerodynamic surface during its integrating into the set of tools according to the present disclosure.

To this end, the skin which can be acoustic according to the sound attenuation needs required is produced thanks to a mold outside the set of tools according to the present disclosure, of which the outer drape molding surface of said mold is similar to the outer surface formed by the holding walls of the assembled keys.

The outer surface of the mold is a continuous surface which exhibits no surface discontinuity on the drape molding area. The drape molding is achieved for example by pressing against the mold of several carbon plies, pre-impregnated or not with resin. Then, the mold and the carbon plies undergo a polymerization step, that is to say, heating in a furnace in order to give the plies the required stiffness.

Obviously, other molding methods may be applied to the producing of the acoustic skin, such as for example the molding method by resin transfer (RTM for Resin Transfer Molding), or even the molding method by resin infusion.

The acoustic skin exhibits a surface of revolution of approximately 330°, corresponding to the angle between the flanks of the rails along which the single piece cowl of the thrust reverser slides.

To this end, the acoustic skin from the first step of the producing method is open, preferably flexible and of limited thickness, in order to be able to be removed from the mold by elastic deformation of its structure.

Indifferently, the acoustic skin may exhibit a surface of revolution higher than 330°, for example 360°, the extraction of said skin from its mold able for example to be achieved thanks to a device of the type defined in Document FR 12/50482, which is commonly assigned with the present application and the contents of which are incorporated herein by reference in their entirety. When the acoustic skin is drape molded and polymerized, said skin is ready to be set on the set of tools according to the present disclosure.

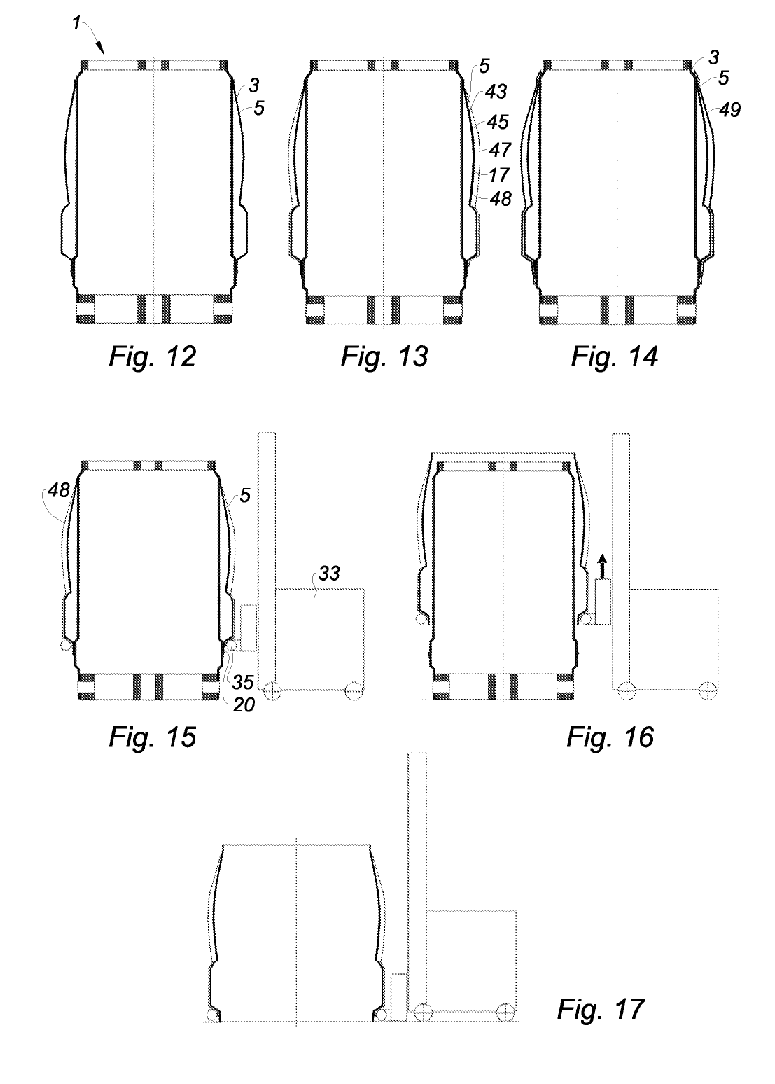

Reference is made to FIGS. 12 to 17, illustrating the rest of the producing method according to the present disclosure.

FIG. 12 represents the set of tools 1 according to the present disclosure, the keys 5 being mounted on the core 3. To this end, it is worth noting that the mounting of the keys on the core is achieved indifferently according to one or the other of the aforementioned mounting methods in reference on FIGS. 7 and 10.

FIG. 13 illustrates the phase of producing an acoustic panel. According to this step of the method, the first skin 43 is positioned, here constituted by an acoustic skin which has already been drape molded and polymerized as aforementioned, on the holding walls 17 of the set of keys 5. The positioning of the acoustic skin is achieved for example thanks to the handling device of which reference is made in the description, or even manually by an operator.

The positioning of the acoustic skin on the set of tools is made possible thanks to the opening provided on said acoustic skin, as aforementioned.

When the acoustic skin is positioned on the set of tools according to the present disclosure, it is necessary to maintain said skin on the set, the tolerance of the mold on which it has been produced able to differ from the tolerance of the set of tools according to the present disclosure.

To this end, the maintaining operation is achieved for example thanks to straps which are positioned at the upper and lower ends of the set, outside the drape molding areas. Maintaining at the central area of the skin is itself achieved either equally thanks to a girding by straps or by freshly depositing the plies called “closing” which are set in the open area of the acoustic skin.

When the acoustic skin is conveniently pressed against the set of tools according to the present disclosure, a honeycomb core structure 45 is fixed, for example by gluing, on said skin.

Then, it is achieved the step of drape molding the second skin 47, inner skin of the acoustic panel, in such a manner as to achieve the acoustic panel 48. To this end, it is fixed, for example by gluing, the carbon plies, pre-impregnated or not with resin.

The set constituted by the set of tools according to the present disclosure and the drape molded acoustic panel is now put under bladder, as FIG. 14 illustrates.

By referring to this figure, the bladder 49 is positioned around the set comprising the set of tools and the drape molded acoustic panel. The bladder is sealed stuck using cement on the core 3 and allows, during polymerization of the set in the autoclave, a proper pressurization, thus allowing a proper gluing between the different components of the part to be manufactured. The bladder 49 is typically positioned at the extreme parts of the core, corresponding to areas not covered by the keys 5.

When the step of placing the bladder 49 is achieved, the set of tools and the pre-cured acoustic panel is placed in the autoclave in order to polymerize the drape molded carbon plies.

The polymerization step comprises heating the set in a furnace under pressure in order to give the plies the required stiffness. During this step, the acoustic skin provides the permeability of the set and constitutes a smooth surface obtained thanks to a mold which does not exhibit any discontinuous surface.

The continuous acoustic skin advantageously allows preventing the resin from penetrating between the spaces defined by the clearances between the keys during polymerization.

Thus, the continuous acoustic skin provides the permeability of the set. The fact of not directly drape molding the acoustic skin on the keys, which are discontinuous, prevents aerodynamic accidents which could occur during polymerization of the set.

Reference is now made to FIGS. 15 to 17, illustrating the phase of extracting the set of tools from the produced part.

When the polymerization step is finished, the bladder is removed from the set and the power lift truck 33 is positioned such as to allow the tightening of the lower part 20 of the set of keys by the grasping brackets 35.

The clearance provided between the supporting wall of the keys and the working wall of the core allows extracting the set constituted by the keys 5 and by the produced acoustic panel 48, said set being capable of being deposited outside the core.

It is worth noting that the keys remain in position in the acoustic panel produced thanks to the unstrippable convex surface of said panel.

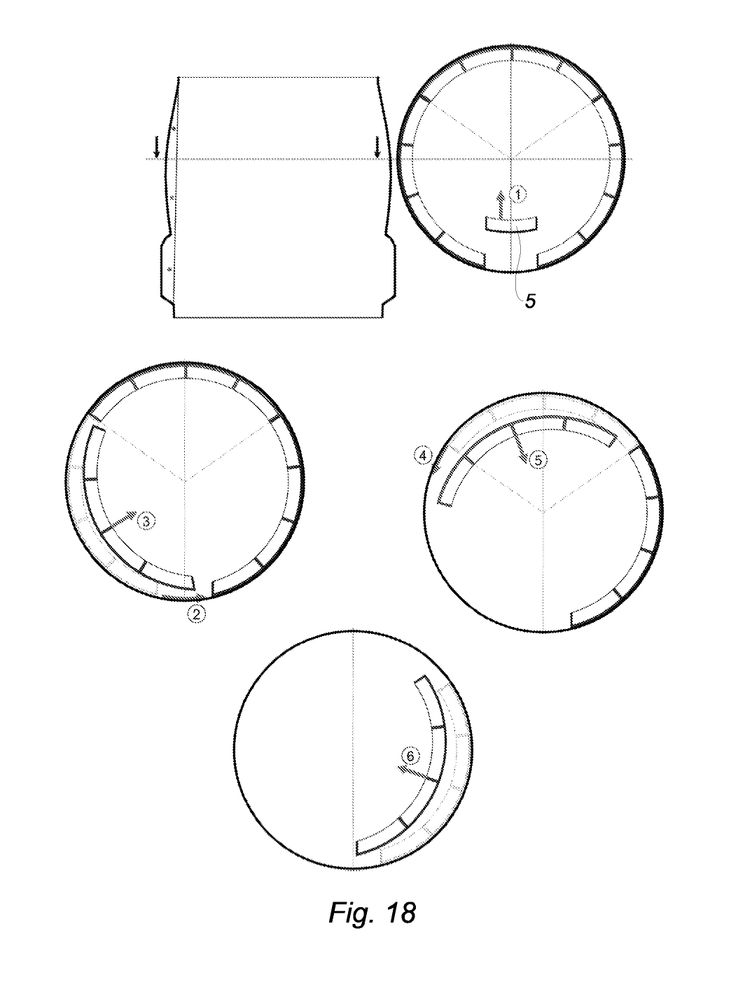

Reference is now made to FIG. 18 illustrating the step of disassembling the keys when said keys are maintained together thanks to the screw and nut set, corresponding to the first aforementioned form of the means for maintaining the keys together.

The disassembling of the keys is carried out one key at a time. It is started by unsecuring a first key 5, which is removed as is illustrated by the step 1 of the disassembling method. The key adjacent to the first key 5 is unsecured from its adjacent key then removed from the set, as is illustrated by steps 2 and 3 in FIG. 18.

The operation is repeated for the totality of the keys forming the set of tools.

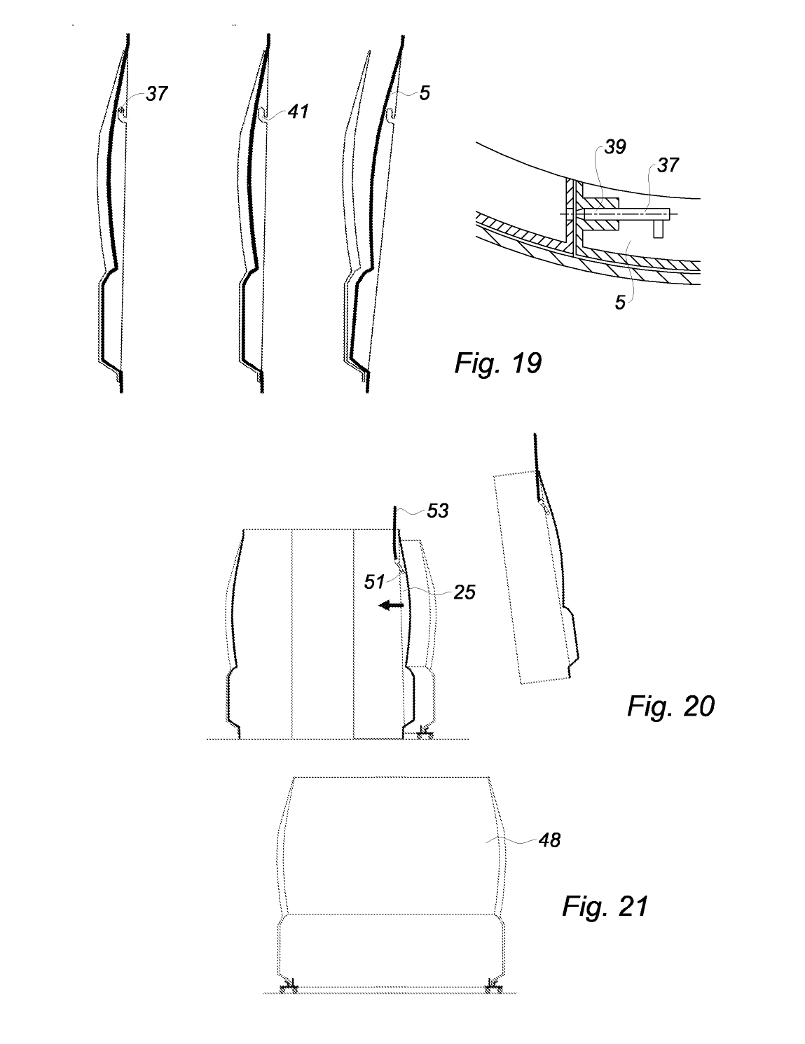

FIG. 19 illustrates the disassembling of the keys when they are maintained together by the sliding bolts, corresponding to the second aforementioned form of the means for maintaining the keys together.

The disassembling of the keys is here achieved by transferring the sliding bolt 37 from the prominent position towards the retracted position.

The extreme part 39 of the sliding bolt 37 is integrally enclosed in a first key 5, thus freeing the locking ramp 41 of the adjacent key, allowing the releasing of the key 5.

The method is repeated for all the keys constituting the set.

When the keys are released according to one or the other of the aforementioned methods, a removal device is provided on a lateral wall 25 of each of the keys. As represented on FIG. 20, this device comprises a lifting ring 51 allowing the hanging of a lifting sling 53. Obviously, several lifting rings may be positioned on the lateral walls of the keys, thus cooperating with several lifting slings.

The acoustic panel 48 resulting from the producing method according to the present disclosure is thus ready for a trimming and machining operation in order to make the part compliant with the assembling requirement, as represented on FIG. 21.

Thanks to the present disclosure, the dimensioning of the composite part to be produced may be accurately met thanks to the clearance provided between the keys mounted on the core, allowing the keys to be displaced around the core, providing a proper centering of the keys on the core.

Moreover, any risk of aerodynamic accident is eradicated during the producing thanks to the producing method according to which a first pre-cured skin from a mold having a smooth continuous surface is deposited.

The present disclosure is not limited to the sole forms of this set of tools, described above only by way of illustrating examples, but encompasses all the alternatives, and in particular the alternative according to which the set of tools no longer comprises a male core but a female core, the working wall of the core thus being constituted by its inner wall and receiving the supporting wall of the keys.

What is claimed is:

1. A set of tools for producing a composite part with a circumference higher than 180° having at least one convex surface which cannot be stripped, said set of tools comprising at least one core and a plurality of keys, at least one of said keys comprising:
at least one supporting wall, a shape of said supporting wall being substantially similar to a shape of a working wall of said core;
at least one holding wall supporting at least in part a first skin of said composite part to be produced; and
at least one lateral wall comprising maintaining means for maintaining together at least two adjacent keys, wherein said maintaining means allow a circumferential clearance between adjacent lateral walls of said two adjacent keys.

2. The set of tools according to claim 1, wherein said maintaining means comprises at least one screw and nut cooperating with the screw.

3. The set of tools according to claim 2, wherein said maintaining means further comprise at least one elastic means configured to allow the circumferential clearance.

4. The set of tools according to claim 3, wherein said at least one nut is housed in inside one of said two adjacent keys, and the circumferential clearance is configured to provide a proper centering of one of said plurality of keys on said at least one core.

5. The set of tools according to claim 1, wherein said maintaining means comprise at least one sliding bolt moveable between a prominent position and a retracted position.

6. The set of tools according to claim 1, wherein at least one lateral wall of at least one key comprises at least one ramp for locking maintaining means.

7. The set of tools according to claim 1, wherein the working wall of said core is of substantially cylindrical shape, and said core comprises at least one handling wall with a diameter larger than the diameter of the working wall.

8. The set of tools according to claim 1, wherein said core comprises a stop for positioning said plurality of keys.

9. The set of tools according to claim 1, further comprising at least two distinct contact areas between said plurality of keys and said core.

10. The set of tools according to claim 1, wherein said core comprises on inside thereof a handling base to be manipulated by an outer handling device.

11. The set of tools according to claim 1, wherein at least one of said plurality of keys comprises at least one lifting ring cooperating with at least one lifting sling.

12. A method for producing a composite part, comprising the following steps:
draping and polymerizing a first open skin with a circumference higher than 180° by means of a mold comprising at least one continuous drape molding surface;
positioning said first open skin on said at least one holding wall of the set of tools obtained according to claim 1;
fixing at least one honeycomb core structure on said first open skin;
fixing a plurality of composite plies on said honeycomb core structure so as to constitute a second skin and form a pre-cured composite part;
positioning a bladder at extreme parts of said core so as to envelop said first open skin, said honeycomb core structure and said second skin;
polymerizing the set of tools comprising the pre-cured composite part and the bladder;
removing the bladder;
extracting a set comprising the plurality of keys and the produced composite part; and
disassembling the plurality of keys.

13. The method according to claim 12, wherein said extreme parts of said core are areas not covered by the plurality of keys.
